(19) United States
(12) Patent Application Publication
(10) Pub. No.: US 2026/0087941 A1
(43) Pub. Date: Mar. 26, 2026

(54) METHODS AND SYSTEMS FOR FACILITATING LEARNING OF A LANGUAGE THROUGH GAMIFICATION

(71) Applicant: Georgina Williams, Blaine, WA (US)

(72) Inventor: Georgina Williams, Blaine, WA (US)

(21) Appl. No.: 19/409,274

(22) Filed: Dec. 4, 2025

Related U.S. Application Data
(63) Continuation-in-part of application No. 19/340,520, filed on Sep. 25, 2025.
Application No. 19/340,520 is a continuation-in-part of application No. 17/113,507, filed on Dec. 7, 2020, now abandoned.
(60) Provisional application No. 62/944,248, filed on Dec. 5, 2019.

(51) Int. Cl. G09B 19/06; G06F 3/01; G06F 3/16

(52) U.S. Cl. CPC G09B 19/06; G06F 3/017; G06F 3/167; G06F 3/018

(57) ABSTRACT

A computer-implemented method for facilitating learning of a language through gamification is disclosed. The method includes receiving, via a communication device, a request for learning the language from a user device and retrieving, from a storage device, a character comprising at least one stroke. A processing device determines a musical sound associated with the at least one stroke and causes the character to be displayed on the user device. The method further includes receiving at least one user stroke generated based on a gesture made by the user, analyzing the at least one user stroke in relation to the corresponding stroke of the character, and modifying the musical sound based on the analysis to generate a modified musical sound. The modified musical sound is transmitted to the user device to provide interactive, music-based feedback during language learning.

### FIELD OF THE INVENTION

Generally, the present disclosure relates to the field of data processing. More specifically, the present disclosure relates to methods and systems for facilitating learning of a language through gamification.

### BACKGROUND OF THE INVENTION

In today's interconnected world, proficiency in a foreign language provides the opportunity to engage with the world in an efficient way. Therefore, learning a foreign language has now become a necessity for students all over the globe. With the current boom of Chinese culture in the west, the popularity and appeal of learning Chinese are greater now than ever before in western culture. Existing techniques for facilitating the learning of a language through gamification are deficient with regard to several aspects. For instance, current technologies do not teach the language through gamification.

Therefore, there is a need for improved methods and systems for facilitating the learning of a language through gamification that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention relates to systems and methods for facilitating the learning of a language through gamification using interactive, music-based feedback. In one aspect, a method is provided in which a request for learning a language is received from a user device. In response to the request, a character is retrieved from a plurality of characters associated with the language, the character including at least one stroke forming the character. A musical sound associated with the at least one stroke is determined, and the character is transmitted to the user device for display. The method further includes receiving, from the user device, at least one user stroke generated based on a gesture made by the user, and analyzing the user stroke in relation to the corresponding stroke of the character. Based on the analysis, the musical sound associated with the stroke is modified to generate a modified musical sound, which is then transmitted to the user device to provide real-time auditory feedback that encourages accurate stroke formation.

In certain embodiments, each stroke of the character is associated with a musical sound determined according to the stroke order, such that sequential tracing of the strokes produces a coherent musical sequence. The musical sound may be a musical note that harmonizes with a portion of a song or orchestral work. In one embodiment, the musical sound may be a portion of a song. The analysis of the user stroke may include evaluating stroke speed, acceleration, or pressure and determining a similarity score between the user stroke and the intended stroke. The modification of the musical sound may include altering its speed, frequency, or amplitude. A reward, such as a number of points, may also be generated and transmitted to the user device based on the user's performance.

In additional embodiments, the plurality of characters includes a plurality of Chinese radicals. Each radical may be associated with an availability state, and characters may be retrieved based in part on the current availability state. The system may further support monetization or point-based unlocking of radicals by receiving purchase requests, analyzing and processing transactions, updating the availability state of purchased radicals, and permitting the user to combine available radicals to form new Chinese characters.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating learning of a language through gamification, in accordance with some embodiments.

FIG. 3 is a flowchart of a method for facilitating learning of a language through gamification, in accordance with some embodiments.

FIG. 4 is a flowchart of a method for facilitating presenting at least one sound portion of a sound for facilitating the learning of the language through gamification, in accordance with some embodiments.

FIG. 5 is a flowchart of a method for modifying the availability state of the character for facilitating the learning of the language through gamification, in accordance with some embodiments.

FIG. 6 is a flowchart of a method for identifying the character for facilitating the learning of the language through gamification, in accordance with some embodiments.

FIG. 7 is a flowchart of a method for configuring the at least one dynamic visual feature of the character for facilitating the learning of the language through gamification, in accordance with some embodiments.

FIG. 8 is an illustration of a user interface of a software application associated with the system 200, in accordance with some embodiments.

FIG. 9 is an illustration of a user interface of a software application associated with the system 200, in accordance with some embodiments.

FIG. 10 is an illustration of a user interface of a software application associated with the system 200, in accordance with some embodiments

FIG. 11 is an illustration of a character breakdown associated with a character, in accordance with some embodiments.

FIG. 12 is a block diagram of a computing device for implementing the methods disclosed herein, in accordance with some embodiments.

FIG. 13 is a flowchart of a method for facilitating learning of a language through gamification, in accordance with some embodiments.

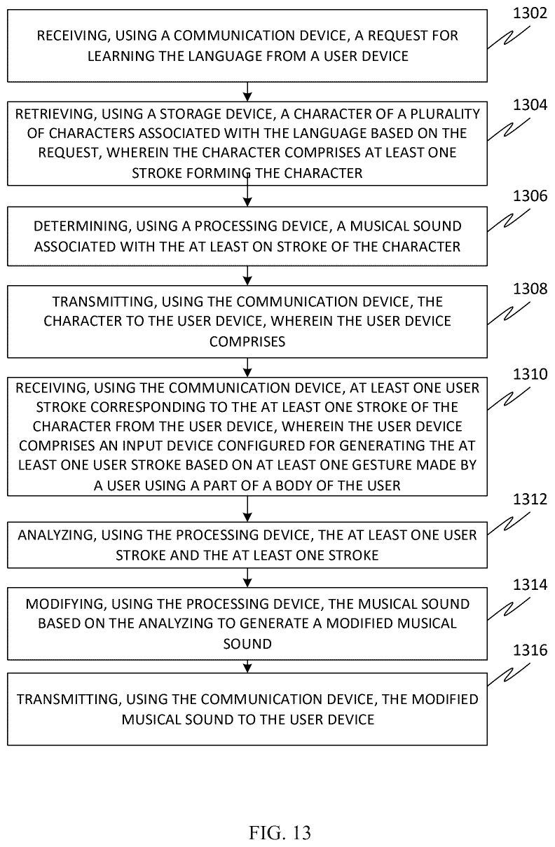

FIG. 14 is a flowchart of a method for facilitating analysis of the strokes, in accordance with some embodiments.

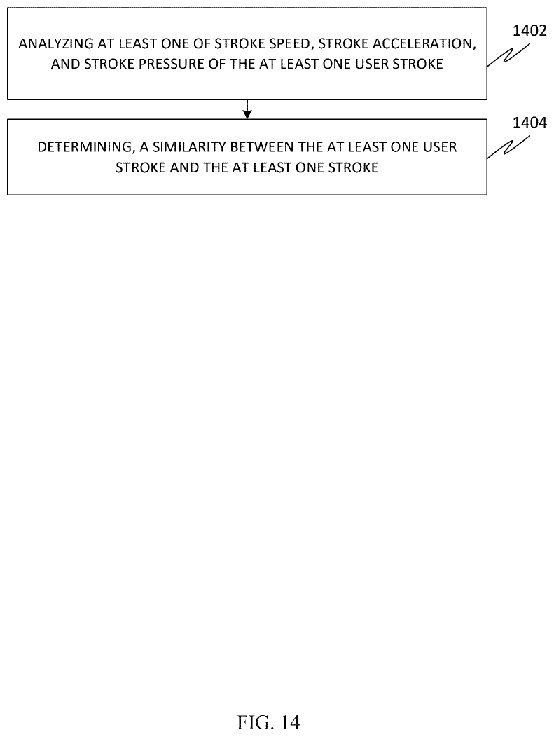

FIG. 15 is a flowchart of a method for providing reward points, in accordance with some embodiments.

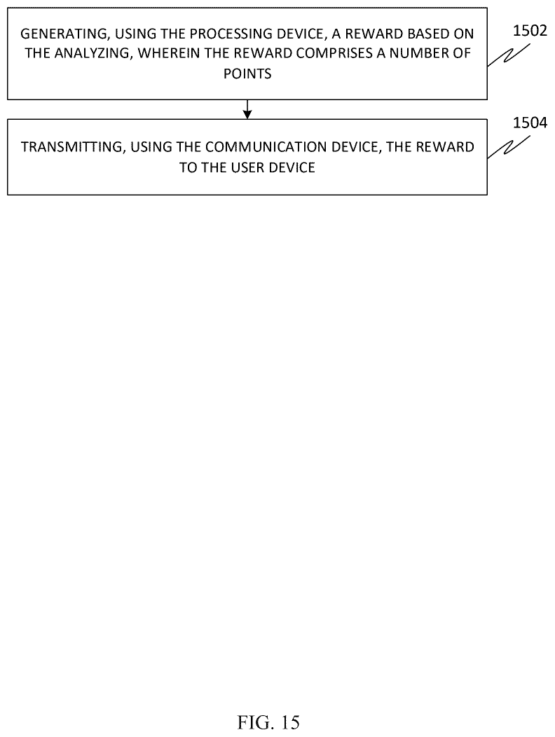

FIG. 16 is a flowchart of a method for modifying the availability state of the Chinese radicals, in accordance with some embodiments.

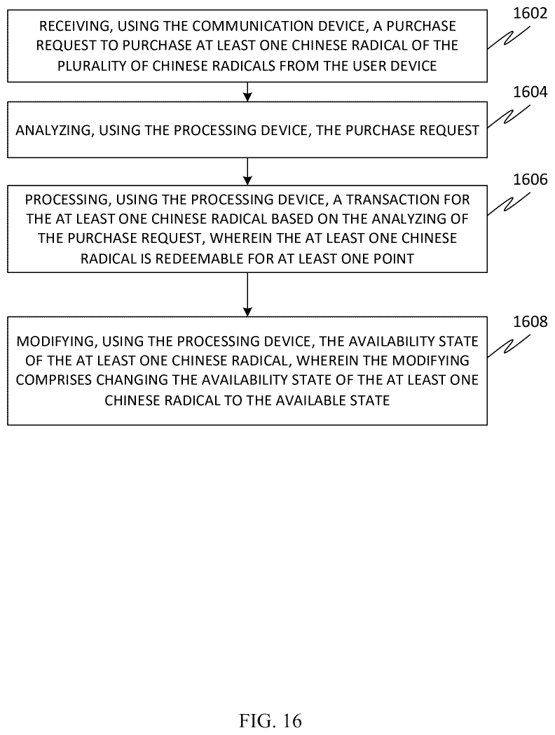

FIG. 17 is an illustration of a user interface of a software application associated with the system, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating learning of a language through gamification, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems for facilitating the learning of a language through gamification. Further, Yongyuan (Forever) Video Game Yongyuan Character Trainer (an exemplary embodiment of the disclosed system disclosed herein) may include an educational video game (or game) that may assist a user in learning a foreign language through the incorporation of user interaction and original music. Further, the disclosed system may be intended for anyone, particularly foreigners, that may be interested in learning how to write, read, and speak Chinese. Further, the disclosed system may assist the user in learning how to write, read, and speak Chinese.

Further, the game may start with the user building/creating an avatar associated with the user. Further, the user may choose to play the game either as a conductor (where the user would hold a baton), or a DJ (where the user may use hand/finger to ‘scratch’). Further, the user may choose music associated with the user, such as, but not limited to classical, EDM, rock, etc. The music may be original so there would be no potential copyright issues involved.

Further, the game may include levels. Further, the levels maybe three in number. Further, the levels may include ‘Beginner’, ‘Intermediate’, and ‘Advanced’. The levels may be determined by the number of strokes, so a beginner may have up to 6 strokes and advanced as many as 14 strokes. The game may include a total of 3000 characters—enough to consider the user fluent.

Further, the user may choose language settings. Further, upon starting, the user may hear the Chinese spoken, see the character written with a movable (or static) picture of the character in the background. As the conductor or the DJ, the user may have a certain amount of time to complete 12 characters before moving on to the next set. Further, upon passing by the user, a Chinese Sensei may descend on a screen (or user interface associated with the game) saying, “Fei Chung Hao” and give the user a gift of points that the user may accumulate throughout the game. Further, the points may be used to buy different character builders as the user move up in the levels.

Further, upon playing the game by the user and passing fingers or baton over the location the strokes would be, there may be arrows above a shadow debossed area to guide the user with the stroke order. Upon drawing each stroke correctly, a sound may be produced that corresponds with the music the user may have chosen. So, the user is “making music” while the user writes. However, the user may move through the levels of the game in silent mode if preferred.

Further, upon completing each level, there may be a graduation ceremony for the avatar associated with the user.

The disclosed system comprises the potential of a story component for the avatar to keep these more interesting while the user learns. Further, the game may be developed for Korean and the Japanese languages as well.

Upon turning on the game by the user, the words “Yongyuan” (written in golden Chinese characters against a black background) may load. Further, the word “Enter” may be written just below the 2 characters. When the user presses enter the characters may part and ‘open’ like two doors, then it fades to black.

Further, the game may load with music playing in the background. On the screen, the user may see a character (e.g. water) with an image of water moving slowly in the background. This soon blurs a bit while a pop-up screen appears with settings. Further, settings may allow the user to choose a language. Further, the pop-up screen may include English (with a small image of the flag beside), Francais, Español, Deutsch, etc. Further, upon choosing the language, then on the pop-up screen, the user may be asked to build the avatar. After uploading a jpg (jpeg) photo associated with the user, the disclosed system may recreate a facial avatar and the user may continue to build the rest of the body of the avatar as the user likes. Further, the user may play the game as one of 3 people: a conductor for an orchestra, a DJ, or a student. Further, the pop-up screen may move on to ask the user to choose the music. Further, the user may choose the music from classical to rock as the user scroll through options with genre headers. Further, the user may have the option to mix it up. Further, the avatar may not match a genre of music. Further, the user may have an option to play in silent mode. Further, the user may be given the option to save the settings.

Further, the pop-up screen and a blurry image of the game may fade to black. After 1-2 seconds, a Chinese sensei (or sensei) may appear on the screen and asks the user (audibly in Chinese), “Do you want to speak Chinese?” The translation in a second language is written underneath (subtitles). Further, after the avatar nods yes, the Chinese sensei may say: “Depending on these two things they press: “Let's practice” [OR]“Let's play”. Further, the user may choose one of “Let's practice” [OR]“Let's play”. Upon pressing on “Let's practice”, the screen may fade to black. A second later, the Sensei and the user may be sitting in a room. Further, the Chinese sensei is in front of the user. They are facing him (so their back is to the screen). He then gets up and sits beside them and smiles gently at the user. Then the Chinese sensei starts writing a first word in the sand with a stick. Further, the Chinese sensei may say, “write here” and points to where the user draws the same with their stick underneath where he wrote. After writing 3 characters successfully, the Chinese sensei may say, “Very good!” (In Chinese) and the wind gently may blow the sand erasing the work and then everything again fades to black.

Further, the game may load with the music playing in the background. Further, the words ‘start’, and ‘review’ may be written in bold on the far-right side of the game. Note: This is how the game may start every time it is turned on after ‘Yongyuan’ doors associated with the game open. If the user doesn't save the settings, then the user may rebuild everything again.

Further, upon pressing start by the user, the user may hear a lady say, “I” (sounds like e) at the same time seeing a thin black square of the Chinese character in an embossed shadow in the middle of it. Behind them will see a grey drawing of actual number one. Further, a word ‘one’ may be seen written in the user's native language at the bottom right corner and written in ‘pinyin’ (the English version of Chinese) in brackets just below the English word (or whichever language the user selected in the settings).

Further, a small arrow may appear, showing which direction to draw. Using a finger or baton, the user may swipe it across the screen from left to right and subsequently, a black line that may be moving with the fingers may soon come to an end with a ‘thud’ (in silent mode), or a pitch that matches the key of the music chosen by the user.

Further, after 10 (or 12) new words are completed within a certain amount of time, the Sensei may appear (like the sensei fell from the sky) on the screen with arms stretched out wide. Further, upon the landing of the sensei, the sensei says, “Fei Chung Hao!” (Very good), and large numbers may start scrolling and end with accumulated points. If the user doesn't make it within a certain amount of time, the screen may disappear and the sensei may appear alone on the screen and say (with a smile), “It's OK. Let's try again” (in Chinese—the Sensei all addresses the user in Chinese).

Once the user completes the first set and the sensei says, “very good”, everything then fades to black and returns to the ‘start’ and ‘review’ mode with the game's music in the background. Further, the user may change the music or avatar in ‘settings’ (that may be found in the top left corner of the screen). The user may choose to review as many times as they want to rack up points and feel super comfortable before moving on to the next set of 10 or 12 characters.

Each set completed may give the user 100 points. At the beginner level, the user may need 5000 points to start buying one or more character blocks. Once the user may have 5000 points, that are in the form of virtual token currency, there may be a new option written under ‘start’ and ‘review’. It may say ‘visit store’. If the user chose to ‘visit store’, the user and the sensei may again appear in a room this time standing facing each other. Further, the sensei may give the user 5000 tokens (RMB) Chinese currency to buy a character block. Further, the sensei may ask the user if the user may want the sensei to go with the user. If the user selects no, then the user may journey from the village to the store alone. It's a three-hour journey because the user may be going on foot. If the user chooses ‘yes’, the sensei may say, “Great! I could use some good exercise.”, and the sensei may journey with the user. Further, a great wall may be seen in the background. Upon the user reaching the market, the user may see a lot of people talking and moving around. Then a lady sitting at a table may ask, “What do you want?”. Further, the lady may be selling the one or more character blocks. Then the user may choose to buy from the different blocks the lady is selling. Some blocks may not be recognized by the user as a beginner. Further, the lady explains that the user may need them in the future. As the user scroll through the different blocks, the lady may be selling, the blocks may be getting ‘bigger’ and magical looking with a description. Further, if the user buys the different blocks, then the blocks may be saved in the game. (More on this in a moment). If the user doesn't buy anything, the user may keep the points. Further, everything may fade to black and the user and the sensei may journey back to the village.

Further, the game may again load with start, review, and if the user didn't buy anything, the ‘visit store’ may still be there. If the user bought the character block of the one or more character blocks, then the user may only see the character block after pressing play and the game loads the character they need to draw in the middle, etc. However, this time another strip (think scrabble) loads at the top of the square with the character block waiting to be used. Depending on how many character blocks the user eventually purchases, the user may have up to 3 rows: one directly above the square and two to the right and left of the square making the square bigger. When the user has the opportunity to use the character block, the user may drag it down (or across depending where it's kept) with the finger or baton to where it needs to be (again the character will be a shadowed embossed look when nothing is drawn). Further, the character block may be slipped in like a puzzle. Further, it doesn't need to be drawn for saving time when the user advances up and up throughout the game. Further, upon the user reaching the end of the beginner level, the sensei may say, “Get ready for your graduation!” Then it fades to black. Further, the user's avatar may find himself or herself dressed in graduation regalia being part of a grand, elaborate graduation ceremony where the user may receive a medal of honor after the name of the user is called. Before the name is called, the user may see other students being honored (cheering and applause are heard). Further, on the podium, the user may see professors including the Sensei. Further, the avatar with the class with bow/nod with respect and say, “Xie xie nimen.” (Thank you all). The Sensei may go to the podium and declare (in Chinese), “We are a people of community. Welcome!”

Further, a character block of the one or more character blocks may be a building block associated with one or more words in the Chinese language. Further, the building block may be used to create the one or more words. Further, the building block may include one or more word portions of one or more words. Further, the one or more word portions may form the one or more words associated with the building block. For example, a word of the one or more words may include “shi”. Further, the one or more word portions of the word “shi” may include “pi zi di”. Further, the one or more words associated with the building block may include “wo shi hen gao xing”. Further, the user may purchase the building block once the user reached a certain number of points.

Further, the Yongyuan Character Trainer (an exemplary embodiment of the disclosed system disclosed herein) may allow the user to learn to read and write Chinese characters through a series of gestures and music. Further, the Yongyuan Character Trainer may be a paid application. Further, content associated with the Yongyuan Character Trainer may be earned in the game. Further, the game may be associated with a 3D camera (or camera), character, and environment. Further, the game may provide a 1^{st} and 3^{rd} person perspective view. Further, the game may allow the user to learn and trace by finger tracing/screen gestures for Chinese characters. Further, the game may provide full 3D character control for meta-game. Further, the game may provide landscape orientation. Further, the user may include non-native Chinese speakers. Further, the age of the user may be 8 years to 88 years. Further, the game may be associated with iOS™ and Android™. Further, the game may include game modes such as practice, beginner, intermediate, and expert—trace the music mode. Further, the game may provide a calming experience for the user (or player) to unwind and learn a new skill while playing the game. Further, the game may provide a relaxing experience that may allow the player to learn to draw over 1000 Chinese characters. Further, learning to write Chinese experience is a skill that many users aspire to achieve. Further, the player may take as much time as the player likes, repeat the levels, and enjoy progressing at a pace associated with the player. Further, the player may view, learn, and trace Chinese character symbols. Further, the player may be accompanied by the sensei that may be a wise old Chinese teacher. Further, the sensei may guide the player from absolute beginner to understanding more than 1000 Chinese characters. Further, training sessions may take place in a school environment where the sensei may write the Chinese characters into the sand with a stick (view and learn). Further, the player may attempt to trace (or complete) the characters. Further, the player may pass the levels upon drawing the Chinese characters. Further, upon successfully passing the levels by the player, the player may be rewarded with star ratings and coins. Further, the coins may be used for new level unlocks (more Chinese characters to view, learn, and trace) and items to customize the avatar. Further, the game may switch between 3^{rd} person and 1^{st} person perspective as the player creates and modifies the avatar (or character avatar) throughout the training sessions. Further, the player may purchase a whole host of character accessories to have a personalized experience. Further, the player must purchase the Chinese characters to progress in the game. Further, “Yongyuan” in the Yongyuan Character Trainer may mean forever, permanent, perpetuity, evermore, everlasting, eternity, once, and for all. Further, the Character in the Yongyuan Character Trainer may be associated with the avatar and the character blocks. Further, “Trainer” in the Yongyuan Character Trainer may be associated with the sensei.

Further, the player may see a grand elaborate traditional Chinese school in a peaceful mountainous region of ancient China. Further, the great wall may be seen in a distance, leafy foliage clips the sides of the screen as birds, butterflies, and woodland creatures skitter around. Further, traditional Chinese music may be playing a soothing tune. Further, large black doors (or doors) of the school are closed, and the characters Yongyuan may be present in shimmering golden writing. Further. the player taps the doors to enter the school.

Further, the doors may swing open and the camera moves into the main entrance. Further, the school may be bustling with similar students. Further, a square design with corridors surrounding a central courtyard, Further, upon looking left, a corridor may extend to a history room and to the right, there may be doors that may be locked for rooms such as practice room, music room, and graduation room.

Further, the camera may move closer to the courtyard, outside once more. Further, from high up, the sensei may jump down. Further, the sensei may be a kind elderly man that gracefully walks across the screen towards the player while smiling. Further, the sensei may be beckoning the player to come and join him. Further, the player moves towards the sensei, into the courtyard and the sensei may gesture for the player to sit down. Further, the sensei may walk towards the player to join side by side as the camera tilts forward/down such that the sandy floor may be seen. Further, from the right side of the screen, the sensei's waling cane appears and begins to draw a Chinese character “YI” (the number 1) in the sand in a left to right motion. Further, the sensei may repeat as the wind blows the sand away, removing all but the faintest hint of the character, creating a canvas for the player to attempt. Further, “View, Learn, and Trace” may be an important process of the game.

Further, the player may now swipe the screen with the fingers drawing in the sand in a left to right motion at a place as the faintest character YI. Further, the character YI may glow to show the player is right. Further, the camera may move up and the sensei may move in front of the player. Further, the sensei may say, “Very good!” (in Chinese). Further, language subtitles may be present below for the players to read. Further, the sensei may reward the player with coins and stars (XP) and guides the player back into the school, introducing the player to the shop (to purchase the Chinese characters blocks), practice rooms (for free play mode), music room (to select the genre of music for the character) and trophy room (achievements). Further, the player may be free to explore the school at a user's pace. Further, the player may create the character in a room, and when ready, begin the next level.

Further, the player may create and update the avatar (or in-game 3D avatar), including facial features, skin color, ethnicity, and clothes/accessories. Further, the player may spend the coins that may be earned by completing the levels. Further, the player may purchase the clothes/accessories for the avatar and the character blocks to use in subsequent levels associated with the levels.

Further, the game may be driven by an economy spreadsheet where all levels, measures, the character blocks, and the coins rewards may be managed and balanced. Further, the game may be associated with a currency that may include coins. Further, the game may be associated with collectables (such as the character blocks). Further, the character blocks that may be mystery boxes—these may be found at Sue's shop.

Further, after an onboarding experience guiding the player through a core loop, the users may choose a practice mode or play mode. Further, the practice mode allows the player to view, learn, and trace previously attempted characters. Further, a play associated with the game may be a single-player level progression based experience. Further, in a standard mode associated with the game, the player may be measured by direction, speed, and accuracy. Further, in the music mode, a 4^{th} mechanic may create harmony with consecutive correct strokes in the music genre chosen by the player. Further, the player may be rewarded with a “congratulations” screen associated with the game when the player passes a level of the levels. Further, the player may be given a star rating based on the measures (directions, speed, and accuracy) and the coins to spend in the shop. Further, the player may earn the stars by practicing and completing the levels. Further, the stars may be used to acquire clothes, accessories, or points to help ensure the player does not get bankrupt. Further, upon completing a set of Chinese characters, the player may be guided to the graduation room by the sensei. Further, the sensei may be present with the player with a lantern trophy. Further, the settings may launch languages (subtitles/localization) includes English, +up to 10 other languages.

Further, a core loop associated with the game may include 4 steps. Further, a first step of the 4 steps may include loadout (temple) for selecting a game mode. Further, in the loadout, the player may select the game mode and the sensei guides the player into the courtyard to begin the level. Further, a second step of the 4 steps may include play. Further, the player may choose the Chinese characters (from the inventory) to view, learn, and trace. Further, the sensei may write the characters into the sand and the players trace them. Further, the player may pass/quit/fail/retry within the level. Further, a third step of 4 steps may include a level reward (courtyard) for collecting the coins, the stars, and unlocking the content. Further, the player may be rewarded with the coins and the stars upon passing the level. Further, the sensei may guide the player back to the school, Further, the sensei may guide the player to the graduation room upon unlocking an achievement. Further, a fourth step of the 4 steps may include exploring Chinese history for achievement and visiting a room for purchasing the accessories and travelling to Shanghai for Chinese character blocks (or the character blocks). Further, the player may be free to explore parts of the school rooms associated with the game. Further, the player may visit the shop to purchase the accessories for the avatar. Further, the player may visit the shop to purchase the Chinese character blocks to be used in the play mode.

Further, the character block may include carved wooden blocks that may include Chinese characters on the character block. Further, the character block may count as individual radicals, for instance, pi zi di, shi zi pang, and so on. Further, the player may purchase the character block from the shop that may allow the player to select the set or the individual characters to play.

Further, a level summary screen associated with the game may display the player achieving 3 stars for efforts made by the user. Further, each of a measuring criteria may reward the player with the coins. Further, the measuring criteria may include direction, speed, and accuracy. Further, a reward associated with the direction may be 10 coins. Further, a reward associated with the speed may be 10 coins. Further, a reward associated with the accuracy may be 10 coins. Further, the player may earn 30 coins. Further, the player may tap to collect the coins and the coins may fly up to the HUD. Further, the game may return to the courtyard and the sensei that may be waiting may be seen. Further, the sensei may head back to the entrance of the school. Further, the sensei may direct the player to a shop in Shanghai (a journey to take alone or together). Further, the shop may include 3 sections. Further, a first section of the 3 sections may include the clothes/accessories. Further, a second section of the 3 sections may include the Chinese character blocks. Further, a third section of the 3 sections may include the music—instruments, genres, and bands (tracks). Further, for the player to meet Su, the player may hear a historical fact about China on the way to the market where Su is. Further, the Su may be a young girl that may work in the shop. Further, the young girl may stand behind a counter surrounded by a huge range of clothing and a variety of other gadgets, musical instruments, and a special looking box (such as the Chinese character block) on the counter. Further, on one side of the counter may be a full-length mirror. Further, Su may gesture towards the full-length mirror, and the camera may center on the full-length mirror.

Further, the player may create the 3D avatar and through a series of simple selections (or choices), the player may choose the head, body, skin, face, ethnicity, and a basic set of clothing. Further, the player may name the character associated with the player. Further, the player may return to the counter and may browse through items for sale in the shop. Further, the items available for 30 coins may include the Chinese individual character and radical blocks. Further, the player may purchase the items and leaves the shop. Further, the sensei may guide the player back to the school or fade out from the shop and fade in back to the school. Further, a door associated with the practice room may be now unlocked. Further, the player may now go to the practice room and practice “YI (1)” again if the player may want to. Further, the player may go to the courtyard and repeat for a next set of the character.

Further, the player may unlock one or more character blocks and open remaining doors of the school (music mode), ultimately opening the graduation room that may store certificates and the character blocks that the player may have unlocked and completed (using a bronze, silver, gold system of achievement). Further, upon completing the levels by the player, the sensei may declare: “We are people of community. Welcome!”.

Further, in and around the temple, the player may be in 1^{st} person perspective. Further, the player may switch to 3^{rd} person perspective. Further, in the 3^{rd} person perspective, the player may look the avatar. Further, the player may tap on a left side of the screen and use standard direction controls to move forward/back/left/right. Further, the player taps and hold/move on a right side of the screen to control an angle of view up, down, and strafe left/right too. Further, the left/right options may be swapped in the settings.

Further, a fun element associated with the game may include the player choosing the musical genre to roleplay with the character. Further, the player may choose from Rock, Pop, Dance (EDM), and Classical. Further, upon playing a musical character, the Chinese characters traced in the play mode may emit certain sounds/SFX associated with the musical character. Further, in an instance, a rock star may emit a guitar string on a successful stroke of the character.

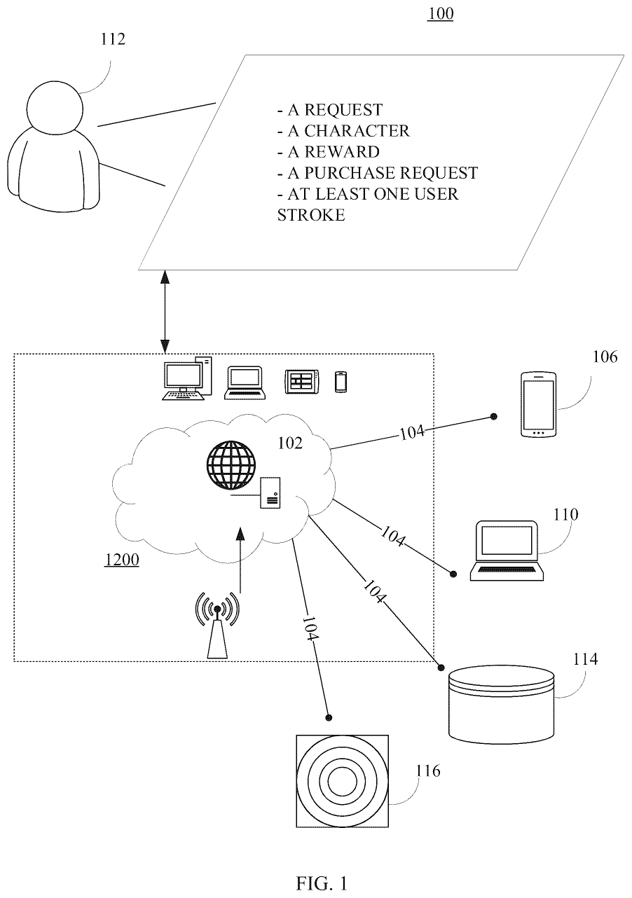

Referring now to figures, FIG. 1 is an illustration of an online platform 100 consistent with various embodiments of the present disclosure. By way of non-limiting example, the online platform 100 to facilitate the learning of a language through gamification may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1200.

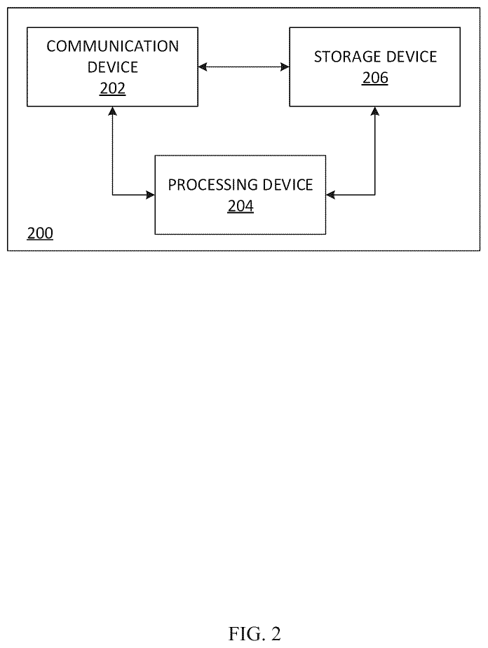

FIG. 2 is a block diagram of a system 200 for facilitating learning of a language through gamification, in accordance with some embodiments. Accordingly, the system 200 may include a communication device 202 configured for receiving a request for learning the language from a user device. Further, the user device may include a computing device such as, but not limited to, a smartphone, a tablet, a smartwatch, a laptop, a desktop, and so on. Further, the communication device 202 may be configured for transmitting a character to the user device. Further, the user device may include a display device configured for displaying the character. Further, the communication device 202 may be configured for receiving at least one user stroke corresponding to at least one stroke of the character from the user device. Further, the user device may include an input device configured for generating the at least one user stroke based on at least one gesture made by a user using a part of a body of the user. Further, the communication device 202 may be configured for transmitting a reward to the user device. Further, the at least one gesture may include at least one movement of a finger of the user on the input device. Further, the input device may include a touchscreen device. Further, the touchscreen device may be configured for generating the at least one user stroke based on the at least one movement of the finger on the touchscreen device.

Further, the system 200 may include a storage device 206 communicatively coupled with the communication device 202. Further, the storage device 206 may be configured for retrieving the character of a plurality of characters associated with the language based on the request. Further, the character may include the at least one stroke forming the character. Further, the character may include an alphabet, a number, a word, etc. Further, the language may include a Chinese language, a Japanese language, a Korean language, etc. wherein the Chinese language may include Mandarin, Cantonese, Shanghainese, etc. Further, the at least one stroke may include downstroke, overturn, under turn, compound curve, oval, ascending loop, etc.

Further, the system 200 may include a processing device 204 communicatively coupled with the communication device 202 and the storage device 206. Further, the processing device 204 may be configured for analyzing the at least one user stroke and the at least one stroke. Further, the processing device 204 may be configured for determining a similarity between the at least one user stroke and the at least one stroke based on the analyzing. Further, the processing device 204 may be configured for generating the reward based on the determining. Further, the reward may include a number of points.

Further, in some embodiments, the storage device 206 may be configured for retrieving at least one sound portion of a sound associated with the at least one stroke of the character based on the determining of the similarity. Further, the communication device 202 may be configured for transmitting the at least one sound portion to the user device based on the retrieving. Further, the user device may include an audio output device configured for presenting the at least one sound portion. Further, the at least one sound portion may include a note of a melody. Further, the sound may be the melody. Further, the audio output device may include a speaker.

Further, in some embodiments, each character of the plurality of characters may be associated with an availability state. Further, the availability state may include an available state and an unavailable state. Further, the retrieving of the character may be based on the availability state of the character.

Further, in some embodiments, the communication device 202 may be configured for receiving a purchase request to purchase at least one character of the plurality of characters from the user device. Further, the processing device 204 may be configured for analyzing the purchase request. Further, the processing device 204 may be configured for processing a transaction for the at least one character based on the analyzing of the purchase request. Further, the at least one character may be redeemable for at least one point. Further, the processing device 204 may be configured for modifying the availability state of the at least one character. Further, the modifying may include changing the availability state of the at least one character to the available state.

Further, in some embodiments, the communication device 202 may be configured for transmitting a plurality of character representations of the plurality of characters to the user device. Further, the communication device 202 may be configured for receiving a character indication associated with a character representation of the plurality of character representations from the user device. Further, the processing device 204 may be configured for identifying the character based on the character representation. Further, the retrieving of the character may be based on the identifying.

Further, in some embodiments, the character may include at least one dynamic visual feature. Further, the at least one dynamic visual feature defines a visual appearance of the character subsequent to the displaying. Further, the at least one dynamic visual feature changes the visual appearance of the character from a first visual appearance to a plurality of second visual appearances subsequent to the displaying. Further, the at least one dynamic visual feature may include an opacity, a transparency, a color, a shape, etc. Further, the first visual appearance corresponds to a first value of the at least one dynamic visual feature. Further, the plurality of second visual appearances corresponds to a plurality of second value of the at least one dynamic visual feature.

Further, in some embodiments, the storage device 206 may be configured for retrieving user information associated with the user. Further, the processing device 204 may be configured for analyzing the user information. Further, the processing device 204 may be configured for determining a level of skill of the user based on the analyzing of the user information. Further, the processing device 204 may be configured for configuring the at least one dynamic visual feature based on the determining of the level of skill. Further, the at least one dynamic visual feature changes the visual appearance of the character from the first visual appearance to a second visual appearance of the plurality of second visual appearances subsequent to the displaying based on the configuring. Further, the user information may include any information associated with language skills associated with the language acquired by the user. Further, the user information may include any information associated with language skills associated with the language acquired by the user.

Further, in some embodiments, the processing device 204 may be configured for generating the user information based on the determining the similarity. Further, the storage device 206 may be configured for storing the user information.

Further, in some embodiments, each second appearance of the plurality of second appearances forms a guide for facilitating tracing of the at least one stroke using the at least one user stroke based on the generating of the at least one user stroke.

Further, in some embodiments, the guide may be characterized by an ability for the tracing. Further, an accuracy of the tracing may be based on the ability of the guide. Further, the accuracy of the tracing corresponds to the similarity between the at least one user stroke and the at least one stroke.

Further, in some embodiments, each stroke of the at least one stroke may be associated with at least one stroke parameter defining the each stroke. Further, the analyzing may include comparing each user stroke of the at least one user stroke with the each stroke based on each stroke parameter of the at least one stroke parameter. Further, the determining of the similarity between the at least one user stroke and the at least one stroke may be based on the comparing. Further, the at least one stroke parameter may include a shape, a style, a direction, a speed, etc. associated with the at least one stroke.

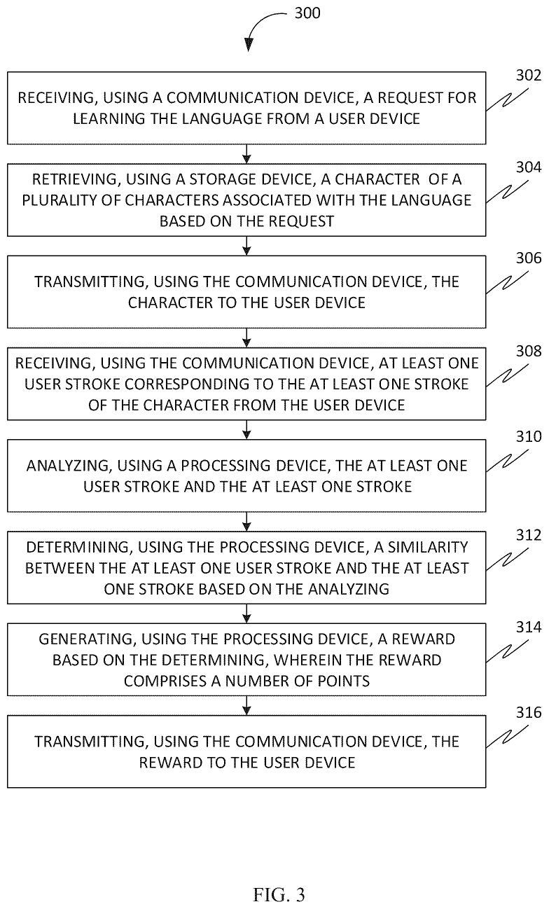

FIG. 3 is a flowchart of a method 300 for facilitating learning of a language through gamification, in accordance with some embodiments. Accordingly, at 302, the method 300 may include a step of receiving, using a communication device, a request for learning the language from a user device.

Further, at 304, the method 300 may include a step of retrieving, using a storage device, a character of a plurality of characters associated with the language based on the request. Further, the character may include at least one stroke forming the character. Further, the character may include an alphabet, a number, a word, etc. Further, the language may include a Chinese language, a Japanese language, a Korean language, etc. Further, the Chinese language may include Mandarin, Cantonese, Shanghainese, etc. Further, the at least one stroke may include downstroke, overturn, under turn, compound curve, oval, ascending loop, etc.

Further, at 306, the method 300 may include a step of transmitting, using the communication device, the character to the user device. Further, the user device may include a display device configured for displaying the character.

Further, at 308, the method 300 may include a step of receiving, using the communication device, at least one user stroke corresponding to the at least one stroke of the character from the user device. Further, the user device may include an input device configured for generating the at least one user stroke based on at least one gesture made by a user using a part of a body of the user. Further, the at least one gesture may include at least one movement of a finger of the user on the input device. Further, the input device may include a touchscreen device. Further, the touchscreen device may be configured for generating the at least one user stroke based on the at least one movement of the finger on the touchscreen device.

Further, at 310, the method 300 may include a step of analyzing, using a processing device, the at least one user stroke and the at least one stroke.

Further, at 312, the method 300 may include a step of determining, using the processing device, a similarity between the at least one user stroke and the at least one stroke based on the analyzing.

Further, at 314, the method 300 may include a step of generating, using the processing device, a reward based on the determining. Further, the reward may include a number of points.

Further, at 316, the method 300 may include a step of transmitting, using the communication device, the reward to the user device.

Further, each character of the plurality of characters may be associated with an availability state. Further, the availability state may include an available state and an unavailable state. Further, the retrieving of the character may be based on the availability state of the character.

Further, the character may include at least one dynamic visual feature. Further, the at least one dynamic visual feature defines a visual appearance of the character subsequent to the displaying. Further, the at least one dynamic visual feature changes the visual appearance of the character from a first visual appearance to a plurality of second visual appearances subsequent to the displaying. Further, the at least one dynamic visual feature may include an opacity, a transparency, a color, a shape, etc. Further, the first visual appearance corresponds to a first value of the at least one dynamic visual feature. Further, the plurality of second visual appearance corresponds to a plurality of second value of the at least one dynamic visual feature.

Further, each stroke of the at least one stroke may be associated with at least one stroke parameter defining the each stroke. Further, the analyzing may include comparing each user stroke of the at least one user stroke with the each stroke based on each stroke parameter of the at least one stroke parameter. Further, the determining of the similarity between the at least one user stroke and the at least one stroke may be based on the comparing. Further, the at least one stroke parameter may include a shape, a style, a direction, a speed, etc. associated with the at least one stroke.

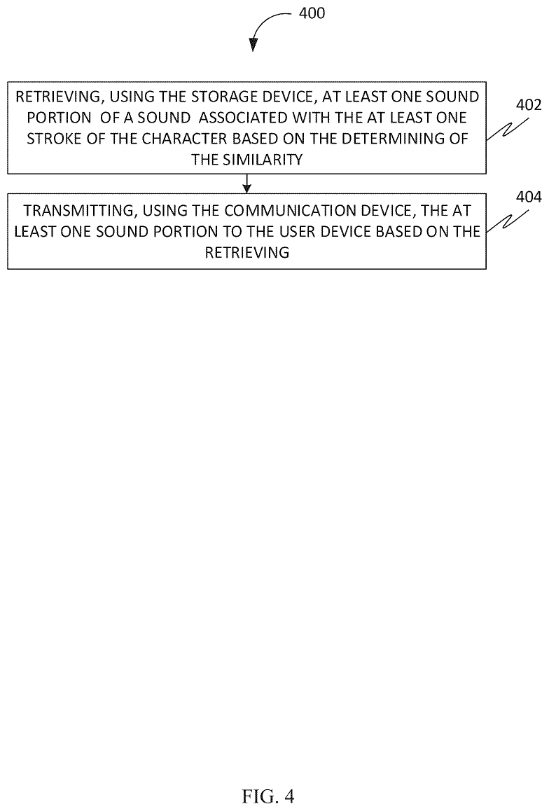

FIG. 4 is a flowchart of a method 400 for facilitating presenting at least one sound portion of a sound for facilitating the learning of the language through gamification, in accordance with some embodiments. Accordingly, at 402, the method 400 may include retrieving, using the storage device, the at least one sound portion of the sound associated with the at least one stroke of the character based on the determining of the similarity. Further, the at least one sound portion may include a note of a melody. Further, the sound may be the melody.

Further, at 404, the method 400 may include transmitting, using the communication device, the at least one sound portion to the user device based on the retrieving. Further, the user device may include an audio output device configured for presenting the at least one sound portion. Further, the audio output device may include a speaker.

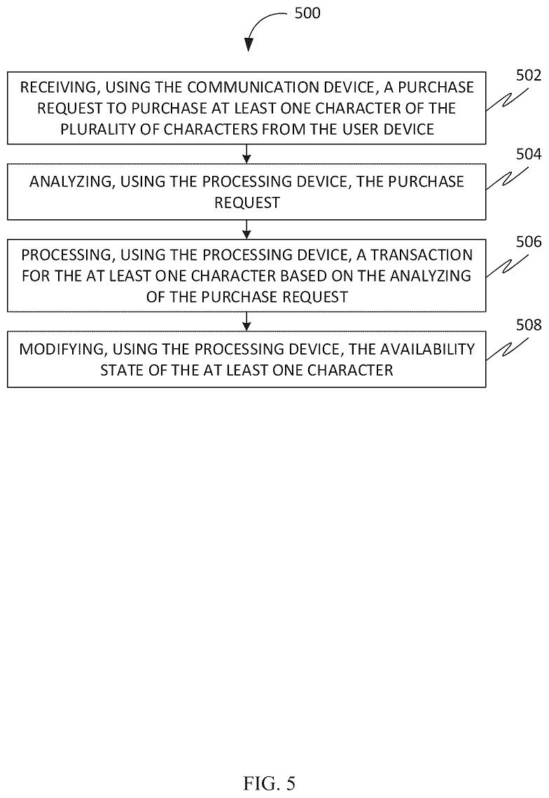

FIG. 5 is a flowchart of a method 500 for modifying the availability state of the character for facilitating the learning of the language through gamification, in accordance with some embodiments. Accordingly, at 502, the method 500 may include receiving, using the communication device, a purchase request to purchase at least one character of the plurality of characters from the user device.

Further, at 504, the method 500 may include analyzing, using the processing device, the purchase request;

Further, at 506, the method 500 may include processing, using the processing device, a transaction for the at least one character based on the analyzing of the purchase request. Further, the at least one character may be redeemable for at least one point.

Further, at 508, the method 500 may include modifying, using the processing device, the availability state of the at least one character. Further, the modifying may include changing the availability state of the at least one character to the available state.

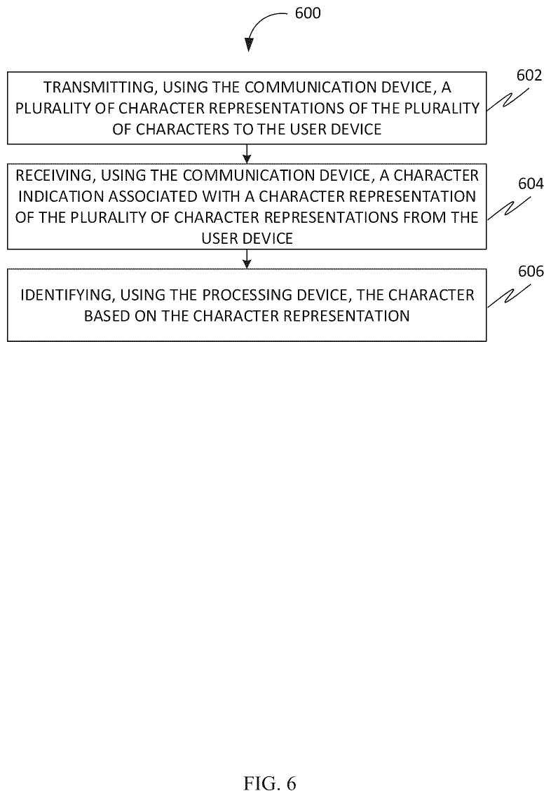

FIG. 6 is a flowchart of a method 600 for identifying the character for facilitating the learning of the language through gamification, in accordance with some embodiments. Accordingly, at 602, the method 600 may include transmitting, using the communication device, a plurality of character representations of the plurality of characters to the user device.

Further, at 604, the method 600 may include receiving, using the communication device, a character indication associated with a character representation of the plurality of character representations from the user device.

Further, at 606, the method 600 may include identifying, using the processing device, the character based on the character representation. Further, the retrieving of the character may be based on the identifying.

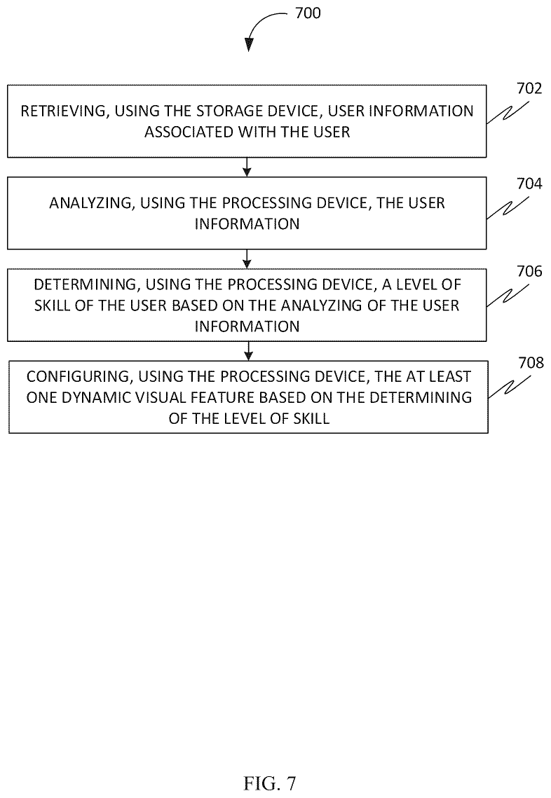

FIG. 7 is a flowchart of a method 700 for configuring the at least one dynamic visual feature of the character for facilitating the learning of the language through gamification, in accordance with some embodiments. Accordingly, at 702, the method 700 may include retrieving, using the storage device, user information associated with the user. Further, the user information may include any information associated with language skills associated with the language acquired by the user.

Further, at 704, the method 700 may include analyzing, using the processing device, the user information.

Further, at 706, the method 700 may include determining, using the processing device, a level of skill of the user based on the analyzing of the user information.

Further, at 708, the method 700 may include configuring, using the processing device, the at least one dynamic visual feature based on the determining of the level of skill. Further, the at least one dynamic visual feature changes the visual appearance of the character from the first visual appearance to a second visual appearance of the plurality of second visual appearances subsequent to the displaying based on the configuring.

Further, in some embodiments, the method 700 may include generating, using the processing device, the user information based on the determining the similarity. Further, the method 700 may include storing, using the storage device, the user information.

Further, each second appearance of the plurality of second appearances forms a guide for facilitating tracing of the at least one stroke using the at least one user stroke based on the generating of the at least one user stroke.

Further, the guide may be characterized by an ability for the tracing. Further, an accuracy of the tracing may be based on the ability of the guide. Further, the accuracy of the tracing corresponds to the similarity between the at least one user stroke and the at least one stroke.

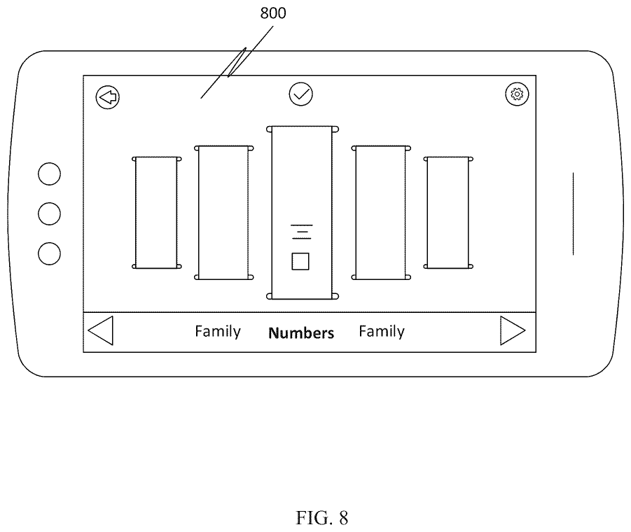

FIG. 8 is an illustration of a user interface 800 of a software application associated with the system 200, in accordance with some embodiments. Accordingly, a player may choose an individual character or set that the player may want to play from a collection of Chinese character blocks. Further, the collection of Chinese character blocks may be organized by categories and may grow throughout the game. Further, the player may scroll the characters within scrolls associated with the game.

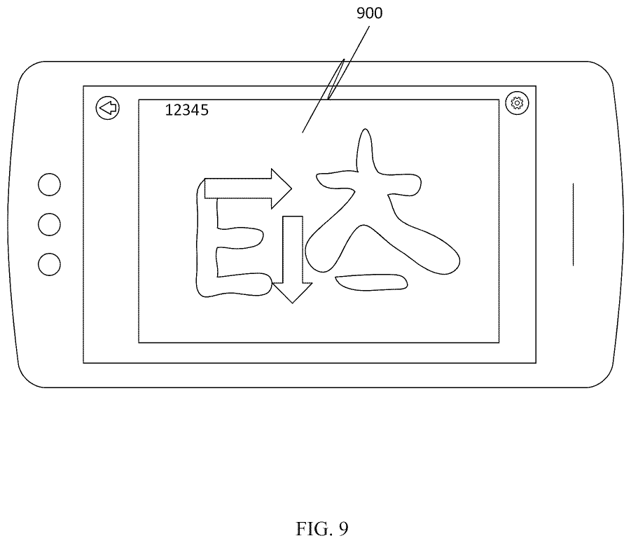

FIG. 9 is an illustration of a user interface 900 of a software application associated with the system 200, in accordance with some embodiments. Accordingly, a sensei may draw the character into the sand in the courtyard with a walking stick of the sensei. Further, the character may stay on the sand until the sand blows the character away leaving just a faint outline for the player to trace. Further, the opacity of the tracing may vary based on difficulty.

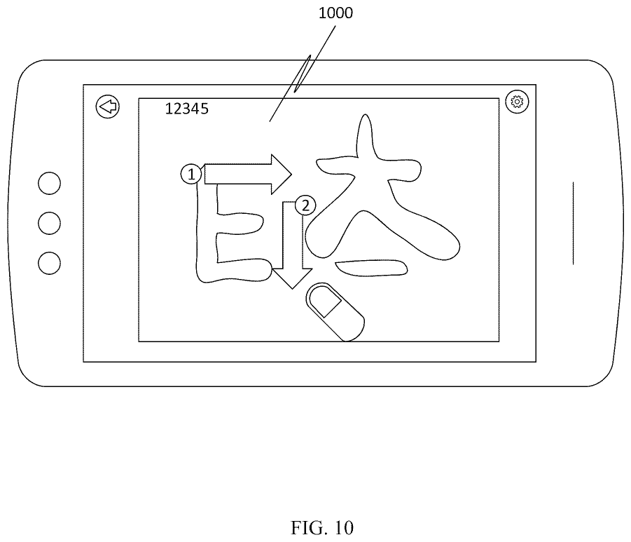

FIG. 10 is an illustration of a user interface 1000 of a software application associated with the system 200, in accordance with some embodiments. Accordingly, the player may use the fingers of the player to trace the character into the sand. Further, the player may be measured for accuracy (staying within the boundaries), direction (copying a path as the sensei), and speed (time taken to complete the character). Further, the sensei may appear and guide the player or the player may retry. Further, upon completing the character by the player, a new character from a set, that the player may be playing, may be drawn by the sensei.

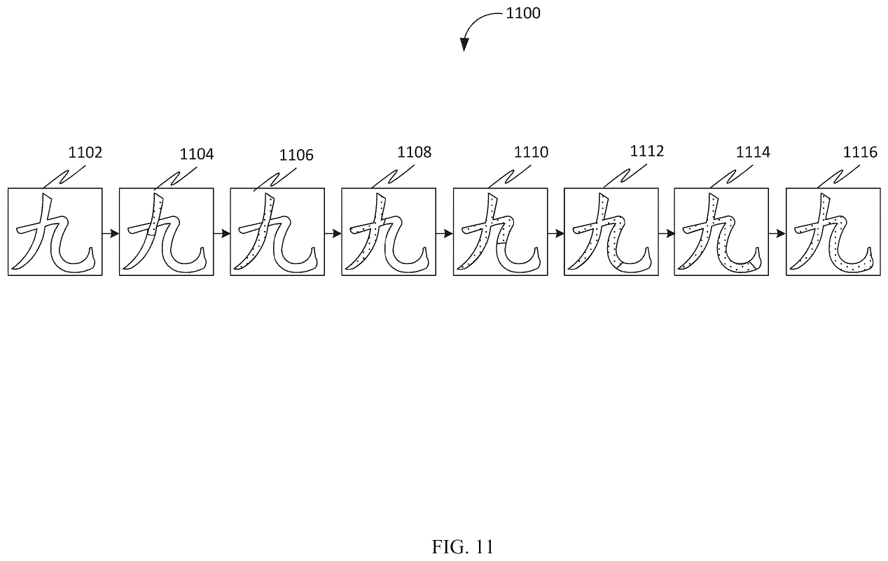

FIG. 11 is an illustration of a character breakdown 1100 associated with a character, in accordance with some embodiments. Accordingly, the character may be associated with a sequence for the player attempting to trace the character associated with a language at a level associated with the game. Further, the sequence may include one or more tracing steps 1102-1116. Further, sets associated with the language may include a plurality of characters that may be associated with subcategories.

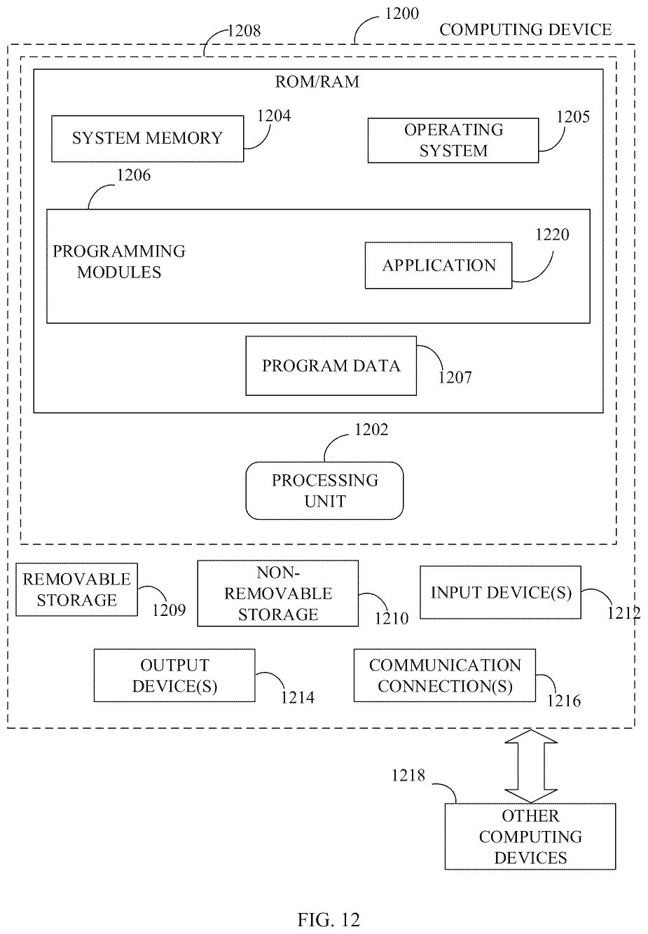

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

In one embodiment, the present invention relates to computer-implemented systems and methods for facilitating language learning through a gamified tracing environment in which musical sounds are associated with strokes of characters and dynamically modified based on a user's tracing performance. The invention provides real-time feedback that enhances the user's understanding of stroke formation, stroke order, and the structural composition of characters.

The storage device maintains a plurality of characters associated with the language to be learned. Each character is represented by a structured dataset that includes at least the stroke count, stroke shapes, stroke sequences, stroke direction vectors, stroke bounding boxes, and stroke-order metadata.

In one embodiment, the invention is implemented using a computer-implemented learning platform comprising a processing device, a communication device, and a storage device in communication with one another. The platform communicates with at least one user device that includes a display device configured for displaying a character and an input device configured for generating user strokes based on gestures made by a user using a part of the user's body.

When a user initiates an interaction with the system, the communication device at step 1302 receives a request for learning the language from a user device. The request may be generated when a user selects a particular lesson, a particular character to practice, a particular radical, or a general learning mode.

The processing device may analyze the request to determine which character, radical, lesson path, or combination thereof should be provided based on the user's learning history, profile information, progress, or availability of characters, including availability states of radicals as discussed below.

Using the storage device, the processing device at step 1304 retrieves a character of a plurality of characters associated with the language based on the request. Each character comprises at least one stroke forming the character.

Each character stored in the storage device includes stroke metadata such as stroke order, stroke direction, stroke path geometry, and stroke count. The retrieval operation may include identifying the correct data structure for the character, loading stroke path vectors or curves, and preparing visual and auditory information associated with the character.

Using the processing device, the method at step 1306 determines a musical sound associated with the at least one stroke of the character. Preferably, the musical sound may be a musical note that harmonizes with a portion of a song or orchestral work. In one embodiment, the musical sound may be a portion of a song. In other embodiments, the musical sound could be a tone, a pitched waveform, a synthesized melody fragment, In one embodiment, the musical sound associated with each stroke is determined based on the stroke order of the character such that consequent musical sounds form a continuous piece of music when the user traces the strokes sequentially. For instance, when user completes tracing a character, the consequent musical sounds may form a continuous melody or a song.

The determining operation may include accessing a musical sound database stored in the storage device that maps strokes or stroke-order indices to musical attributes. It may also include generating acoustic properties digitally using synthesis algorithms. In some embodiments, each stroke is mapped to a pitch frequency, timbre, amplitude envelope, or rhythm element, which is then transformed into a musical output signal.

Once the character and its stroke information are prepared, the communication device at step 1308 transmits the character to the user device. The user device may comprise a display device configured for displaying the character. The transmitted data may include vector-based stroke paths, animation cues, color transitions, guidance overlays, or other visual parameters that instruct the user on how to trace the character.

As the user interacts with the displayed character, the communication device at step 1310 receives, from the user device, at least one user stroke corresponding to the at least one stroke of the character. The user device comprises an input device configured for generating the user stroke based on at least one gesture made by the user using a part of the user's body. The gesture may include touching, pressing, dragging, swiping, tapping, air-drawing, stylus movement, etc.

The processing device at step 1312 analyzes the at least one user stroke and the at least one stroke forming the character. This analysis may include at step 1402 analyzing at least one of stroke speed, stroke acceleration, and stroke pressure of the at least one user stroke, and comparing these parameters to the expected stroke parameters retrieved earlier.

In addition, the analysis may include at step 1404 determining a similarity between the at least one user stroke and the at least one stroke. This can be based on stroke shape, direction, order, geometric error, temporal deviation, or a combination thereof.

Using the processing device, the method at step 1314 modifies the musical sound based on the analyzing. The modification results in a modified musical sound. In one embodiment, modifying the musical sound comprises modifying at least one of speed, frequency, and amplitude of the musical sound.

For example, if the user's tracing speed is higher or lower than expected, the system may increase or decrease the speed of the musical sound. In one embodiment, if the similarity score is high, the system may increase frequency stability or enrich harmonic content; if the similarity score is low, the system may distort or flatten the pitch. If the user's stroke pressure is high, the amplitude of the sound may increase; if low, the amplitude may decrease. The modification is performed in real time or near real time so that the user immediately hears auditory feedback that reflects the correctness or incorrectness of their tracing activity.

The communication device then at step 1316 transmits the modified musical sound to the user device, where it is played through audio hardware.

In one embodiment, the method further comprises at step 1502 generating, using the processing device, a reward based on the analyzing. The reward comprises a number of points. The reward is transmitted at step 1504 to the user device using the communication device.

In one embodiment, the plurality of characters comprises a plurality of Chinese radicals. Furthermore, each radical is associated with an availability state, including an available state and an unavailable state. The retrieving of the character described earlier may be based on this availability state.

In one embodiment, the method may further comprise at step 1602 receiving, using the communication device, a purchase request to purchase at least one Chinese radical of the plurality of radicals from the user device. The processing device at step 16025 analyzes the purchase request. The processing device then at step 1606 processes a transaction for the at least one Chinese radical based on the analyzing of the purchase request. The at least one Chinese radical may be redeemable for at least one point. Upon successful completion of the transaction, the processing device at step 1608 modifies the availability state of the radical by changing the availability state of the at least one Chinese radical to the available state.

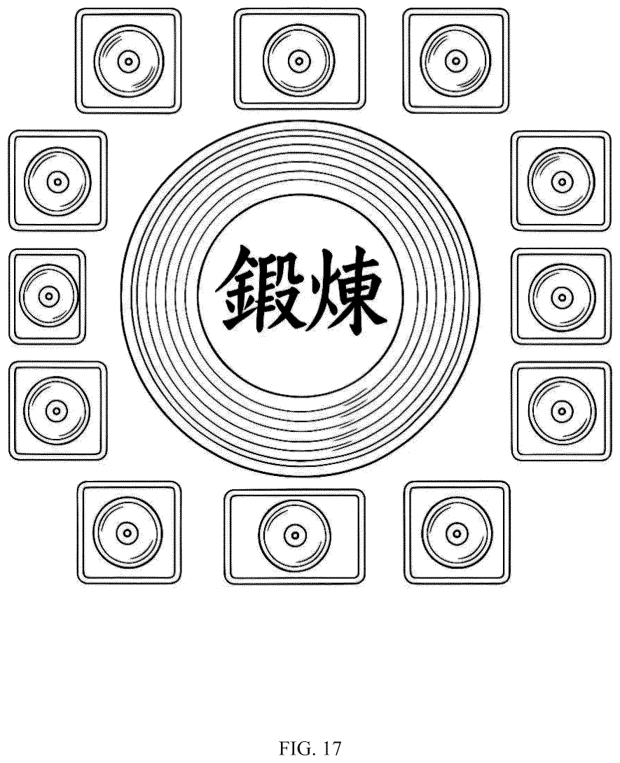

In one embodiment, the method further comprises allowing, using the processing device, the user to combine available Chinese radicals to form a new Chinese character. The system may present an interface for selecting radicals and arrange them spatially to form potential characters. As shown in FIG. 17, the illustrated user interface comprises a plurality of vinyl records that each can hold up a Chinese radical. In one embodiment, the user may drag radicals from multiple vinyl records to form one or more new Chinese characters. The processing device evaluates the combination to determine whether it constitutes a valid character, and if so, may permit the user to learn, trace, and practice the newly formed character using the same methods described above.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating learning of a language through gamification, the method comprising:
receiving, using a communication device, a request for learning the language from a user device;
retrieving, using a storage device, a character of a plurality of characters associated with the language based on the request, wherein the character comprises at least one stroke forming the character;
determining, using a processing device, a musical sound associated with the at least on stroke of the character;
transmitting, using the communication device, the character to the user device, wherein the user device comprises a display device configured for displaying the character;
receiving, using the communication device, at least one user stroke corresponding to the at least one stroke of the character from the user device, wherein the user device comprises an input device configured for generating the at least one user stroke based on at least one gesture made by a user using a part of a body of the user;
analyzing, using the processing device, the at least one user stroke and the at least one stroke;
modifying, using the processing device, the musical sound based on the analyzing to generate a modified musical sound;
transmitting, using the communication device, the modified musical sound to the user device.

2. The method as claimed in claim 1, wherein the musical sound associated with each stroke of the character is determined based on a stroke order of the character, such that consequent musical sounds form a continuous piece of music when the user traces the strokes sequentially.

3. The method as claimed in claim 1, wherein the musical sound is a musical note that harmonizes with a portion of a song or orchestral work.

4. The method as claimed in claim 1, wherein the musical sound is a portion of a song.

5. The method as claimed in claim 1, wherein analyzing the at least one user stroke and the at least one stroke comprises:
analyzing at least one of stroke speed, stroke acceleration, and stroke pressure of the at least one user stroke; and
determining, a similarity between the at least one user stroke and the at least one stroke.

6. The method as claimed in claim 1, wherein modifying the musical sound comprises modifying at least one of speed, frequency, and amplitude of the musical sound.

7. The method as claimed in claim 1, further comprising:
generating, using the processing device, a reward based on the analyzing, wherein the reward comprises a number of points; and
transmitting, using the communication device, the reward to the user device.

8. The method as claimed in claim 1, wherein the plurality of characters comprises a plurality of Chinese radicals.

9. The method as claimed in claim 8, wherein each Chinese radical is associated with an availability state, wherein the availability state comprises an available state and an unavailable state, wherein the retrieving of the character is further based on the availability state of the Chinese radical, the method further comprising:
receiving, using the communication device, a purchase request to purchase at least one Chinese radical of the plurality of Chinese radicals from the user device;
analyzing, using the processing device, the purchase request;
processing, using the processing device, a transaction for the at least one Chinese radical based on the analyzing of the purchase request, wherein the at least one Chinese radical is redeemable for at least one point; and
modifying, using the processing device, the availability state of the at least one Chinese radical, wherein the modifying comprises changing the availability state of the at least one Chinese radical to the available state.

10. The method as claimed in claim 9, further comprising:
allowing, using the processing device, the user to combine available Chinese radicals to form a new Chinese character.

11. A system for facilitating learning of a language through gamification, the system comprising:
a communication device configured for:
receiving a request for learning the language from a user device;
transmitting a character to the user device, wherein the user device comprises a display device configured for displaying the character;
receiving at least one user stroke corresponding to at least one stroke of the character from the user device, wherein the user device comprises an input device configured for generating the at least one user stroke based on at least one gesture made by a user using a part of a body of the user; and
transmitting a modified musical sound to the user device;
a storage device communicatively coupled with the communication device, wherein the storage device is configured for:
retrieving the character of a plurality of characters associated with the language based on the request, wherein the character comprises the at least one stroke forming the character; and
retrieving at least one musical sound associated with the at least one stroke of the character;
a processing device communicatively coupled with the communication device and the storage device, wherein the processing device is configured for:
determining the at least one musical sound associated with the at least one stroke;
analyzing the at least one user stroke and the at least one stroke;
modifying the at least one musical sound based on the analyzing to generate the modified musical sound; and
generating a reward based on the analyzing, wherein the reward comprises a number of points.

12. The system as claimed in claim 11, wherein the storage device is further configured for retrieving a plurality of musical sounds associated with a plurality of strokes of the character based on a stroke order of the character, wherein consequent musical sounds form a continuous piece of music when the user sequentially traces the plurality of strokes.

13. The system as claimed in claim 11, wherein each musical sound comprises a musical note that harmonizes with a portion of a song or orchestral work.

14. The system as claimed in claim 11, wherein each musical sound comprises a portion of a song.

15. The system as claimed in claim 11, wherein the analyzing of the at least one user stroke and the at least one stroke comprises:
analyzing at least one of a stroke speed, a stroke acceleration, and a stroke pressure of the at least one user stroke; and
determining a similarity between the at least one user stroke and the at least one stroke.

16. The system as claimed in claim 11, wherein the modifying of the at least one musical sound comprises modifying at least one of a speed, a frequency, and an amplitude of the at least one musical sound.

17. The system as claimed in claim 11, wherein the communication device is further configured for transmitting the reward to the user device.

18. The system as claimed in claim 11, wherein the plurality of characters comprises a plurality of Chinese radicals.

19. The system as claimed in claim 18, wherein each Chinese radical of the plurality of Chinese radicals is associated with an availability state comprising an available state and an unavailable state, wherein the retrieving of the Chinese radical is further based on the availability state of the Chinese radical, wherein the communication device is further configured for receiving a purchase request to purchase at least one Chinese radical of the plurality of Chinese radicals from the user device, and wherein the processing device is further configured for:
analyzing the purchase request;
processing a transaction for the at least one Chinese radical based on the analyzing, wherein the at least one Chinese radical is redeemable for at least one point; and
modifying the availability state of the at least one Chinese radical, wherein the modifying comprises changing the availability state of the at least one Chinese radical to the available state.

20. The system as claimed in claim 19, wherein the processing device is further configured for allowing the user to combine a plurality of available Chinese radicals to form a new Chinese character.
